(19) United States
(12) Patent Application Publication
(10) Pub. No.: US 2005/0264890 A1
(43) Pub. Date: Dec. 1, 2005

(54) Rear view mirror shade

(76) Inventors: Gerald Angelo Morrone, Verona, PA (US); Louis Samuel Tedesco, Pittsburgh, PA (US)

Correspondence Address: William S. Karn, 664 Lincoln Avenue, Pittsburgh, PA, 15202-3420, US

(21) Appl. No.: 10/851,683

(22) Filed: May 27, 2004

(51) Int. Cl. G02B 5/08

(52) U.S. Cl. 359/601; 359/608

(57) ABSTRACT

A rear view mirror with attenuation of glare from head lights of following highway traffic is the subject of this petition for letters patent. A tinted transparent shade piece is moved in its mounting attachment to swing over the face of the rear view mirror located outside the window on the driver's side of the motor vehicle. A more elaborate design model has a motor incorporated into the glare attenuating tinted transparent shade mounting to enable operation without opening the window and without manual input to move the shade into and out of shading position. Photo sensing device is used to detect glare from following highway traffic and in response, to move the shade into glare attenuation position. One claimed design flips the mirror over to the back side which has lower reflectivity. Another claimed design uses a dual face mirror array. The array is modeled after the common billboard advertising sign that rotates vertical slats to expose several different advertising displays within the same frame area. The present state of the art uses a rear view mirror design with a tilting of the silvered mirror while retaining an attenuated image reflected from the front surface of a cover glass. This invention adds motors and logic sensors to make the process fully automatic.

### BACKGROUND OF THE INVENTION

1). Field of the Invention

This invention relates to headlight glare attenuation viewed by rear view mirror systems mounted exterior to the human operator enclosure cabin of a motor vehicle traveling on the public highway. This invention relates to same mirror device mounted inside the motor vehicle.

2). Background Information

Every motor vehicle traveling on the public highway in conformity to government motor vehicle regulations has a rear view mirror. Many of such motor vehicles have a rear view mirror mounted to the left side of the driver, outside the window. All such motor vehicles (that have no visual obstruction toward the rear along the centerline of the vehicle) have also an inside rear view mirror. In such instance it is common for the inside mirror to have adjustment means for deflecting the intensity of the mirror image away from the face or visual field of the driver. The deflection attenuates the glare of head lights of following motor vehicles during night driving. Prior to creation of this present invention there has been no equivalent means offered to the motoring public to enable attenuation of the head light glare that is reflected off the rear view mirror mounted to the left outside the window where the motor vehicle driver sits.

### PRIOR ART

There appears to be no prior patent that anticipates specifically the full functionality of the present invention. If the invention is analyzed by separating each of its functional components then the analysis can find in general principles comparable light attenuation means, device mounting means, offending light glare origin, etc. The inventive quality lies in identifying a specific problem of significant importance, heretofore not solved and then providing a workable, practical solution. In such an abstract assembly approach, several “prior art” concepts are cited. The requisite assembly process involves inventive steps that would not be obvious to a mechanic of ordinary skill.

There is advertised for sale by others a tinted plastic transparent panel that is to be attached to a sun visor lower edge. The utility of that device is to dim low lying sun rays without completely obscuring an essential portion of the forward view needed for safe operation of the motor vehicle by the driver. The sun visor is hinged and the assembly flips up against the motor vehicle interior ceiling when not needed.

Another light attenuation situation is illustrated by sun glass lenses that clip onto regular optical vision correction lenses. The sun glass lenses can be flipped up out of the field of vision while remaining attached to the full eye glass frame.

The common interior rear view mirror comes with several different glare attenuation activation means. Some have a lever tab that is pulled back. Others have a shaft with tab that is rotated. Each such systems has a full opaque back structure for mounting to the motor vehicle. To that are attached a silvered reflecting surface, and a forward second glass layer which is both transparent and capable of limited reflection from its front surface. The switching lever tab or switching shaft simply acts to deflect the silvered mirror image. That design technique economizes upon device component travel distance. I.e., to disable the arrival of an intense image coming directly from the rear of the motor vehicle requires imparting only a slight tilt to the silvered mirror. That design system also points out the need for an easy method for repositioning with some precision to “off” state and “on” state. I.e., the primary silvered mirror reflector is always restored to its same preferred orientation angle. The overlay transparent glass sustains the delivery of an attenuated image when the main silvered mirror is deflected. The present invention observes that detail of desirable protocol of maintaining a sustained attenuated image by interposing a tinted transparent layer over the silvered mirror layer.

The broad concept for which letters patent is sought is to attenuate the headlight glare, viewed by a motorist, reflected on an outside rear view mirror. One subset of that class is to intercept the light beam with a tinted transparent layer of material that reduces the intensity of the optical image. Such an approach has been presented in some detail above. Another subset class that can solve the problem is to alter the reflectivity of the mirror surface. Within that scope of the invention the following prior art is cited.

It is common to see on the highways advertising signs which carry three different images within the same display area. There are vertical display bars of triangular cross section. Accordingly there are three display surfaces on each bar. By successively in coordination rotating the bars and pausing with a flat bar surface displayed to the viewer there are seen three different advertising images. Per the invention as subject matter of this petition for letters patent that same design structure can be used to display successively either a bright optically clear image reflection surface or an optically clear, attenuating intensity, image reflection surface.

### OBJECT OF INVENTION

It is therefore one object of the present invention to provide a means for attenuating rear view head light glare that reaches a motor vehicle driver that comes via an outside mirror.

Another object of the present invention is to achieve the first stated objective with a device that is easily retrofitted to existing outside mirrors and does the job required at a very modest equipment cost.

Another object of the present invention is to achieve the first stated objective with a device that operates automatically, without intervention and without decision required of the motorist.

Another object of the present invention is to incorporate the automatic operation features referenced above into the rear view mirror commonly located inside the motor vehicle.

### BRIEF DESCRIPTION OF THE INVENTION

A purpose of the present invention is to protect the field of vision of a night time driver of a motor vehicle from the glare of head lights of following motor traffic when the glare comes from reflection from the outside rear view mirror of the lead motor vehicle. A solution is to place a tinted transparent cover over the silvered mirror optical system. Another solution is to rotate the silvered mirror surface out of view.

Typically during the daylight hours the outside rear view mirror is needed with full optical transmission with no loss of image intensity. (A possible exception might occur with a low lying intense morning sun producing a disturbing glare from the rear.) In any case, it is incumbent that the glare attenuation be activated and deactivated easily and quickly.

Improvements that make automatic the apparatus performance as stated above for an outside mirror are then incorporated into the motor vehicle rear view mirrors used inside the motor vehicle.

All of the above considerations are addressed further in the detailed description of the invention below.

### BRIEF DESCRIPTION OF THE DRAWINGS

FIG. 1 is a full face view of the transparent tinted shade and of hinge that joins shade to device fastening means and device fastening means that joins the total assembly to an existing outside rear view mirror.

FIG. 2 is a view of a hinge with detent mechanism that holds the hinge opening angle at either of two functional positions, i.e. rear view glare attenuated or rear view full clear undimmed view.

FIG. 3 is the part assembly of FIG. 2 but flipped over to show its other face.

FIG. 4 shows a detent design variation

FIG. 5 shows a housing shell for the mirror where the shell has a flat spot at the top to accommodate screw fasteners or epoxy cement to hold fast the hinge part shown in FIG. 2 and FIG. 3.

FIG. 6 shows an arrangement of a motor drive to operate the mirror attenuation shade between shading position and clear view position.

FIG. 7 shows a rotating triangular bar mirror structure driven by a motor.

FIG. 8 shows FIG. 7 triangular bar drive enlarged.

FIG. 9 shows a front view of the array of mirror elements.

FIG. 10 shows a block diagram of a fully automatic, power operated glare attenuation system.

FIG. 11 shows a mirror on gimbals that allow the mirror to be flipped over 180 degrees.

### DETAILED DESCRIPTION OF THE INVENTION

The light attenuating tinted transparent shade may be fabricated from plastic polymer sheet stock readily available from any of many supply stores. The tinted transparent shade could be of any transparent material including glass. The material is cut to the size of the rear view mirror face to be covered. A mounting means is attached to the shade and the shade attached to the mirror housing shell by threaded fastener, polymer cement, rivet, melt fastening or whatever.

The shade has two functional service positions. Position one is that the shade covers the silvered mirror surface view. Position two is that the shade is in the horizontal oriented plane. clear of the optical path and in line with the direction of the wind when traveling so as not to be blown out of position by the wind.

The word “silver” or “silvered” or “silvered mirror” as used in this writing is not meant to restrict itself to the metal element silver but is used in the common parlance of designating any opaque shinny reflective surface that is capable of reflecting back a clear optical image.

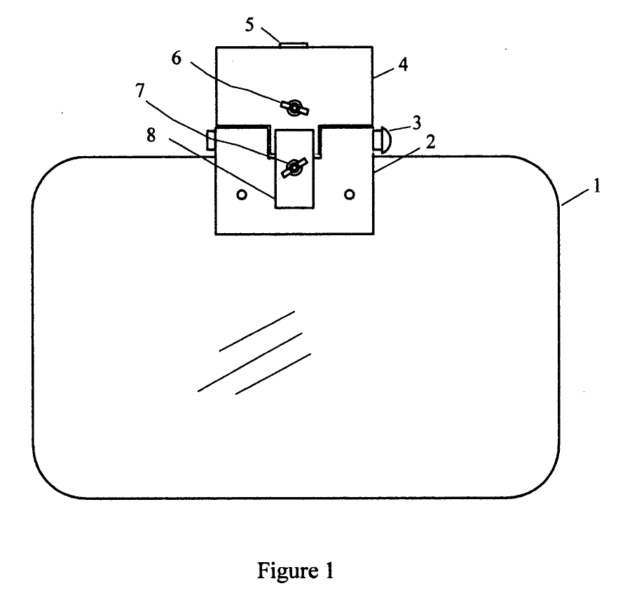

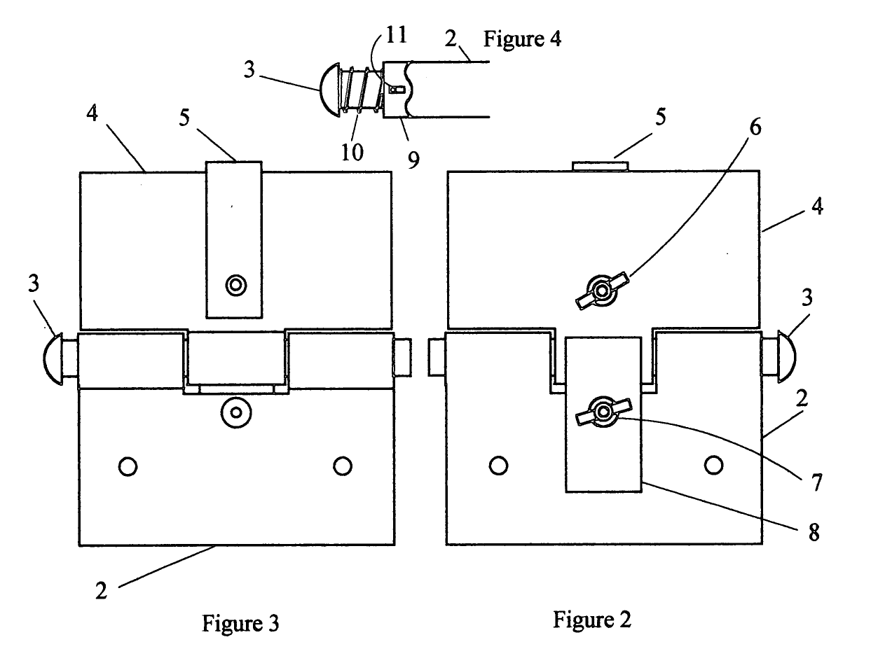

The term “detent” identifies a mechanical arrangement of a spring loaded (or gravity loaded) object that moves into a recess to act as a shear member to resist movement of one frame piece relative to another frame piece. A reasonable force applied to one frame piece pops the object out of the recess to allow the one frame piece to move relative to the other frame piece. The terms “clip” and “latch” are generically close to being the same mechanism as a detent The reader may note per drawing FIGS. 1 and 2, showing piece 8 that if piece 4 is fashioned with flat, 90 degree square contour sides where piece 8 bears against piece 4, that configuration produces a detent action. Another detent configuration can be implemented with a helical spring around pin 3 in conjunction with a wavy cylindrical collar pressing against piece 2. A holding permanent magnet is another approach. Rather than trying to identify by detailed description all possible quick snap positioning means only a few are described here and it is assumed that any skilled craftsman can produce an appropriate functional structure.

The terms “detent” and “holding magnet” (magnet being yet another possible latching means) seem to imply that a holding force is to be overcome suddenly by a greater opposing force. The resultant is a displacement shear force across the detent movement plane. The terms “clip”, “hook”, “hasp”, “latch”, “quick release”, “catch” suggest means for avoiding the requirement for beefed up mounting means required with a detent. Muscular input lifts the latching free. That step then allows easy movement of the shade to its alternate position, and drops the latch into its new holding position. This declaration of terminology is prelude to its usage below in further description of the invention.

The invention solves a need. A casual survey of the cars on the highway today shows a common outside rear view mirror design. There is a shell cowling or shell case that is rigidly fixed to the car. Within the cowling cavity is mounted a silvered mirror. The position angle of the mirror can be reset over small rotational limits. There is a recess slot or gap between the holding cowling (also called case) and the silvered mirror glass. For that specific part design it is feasible to insert a clip that grasps the holding case across the edge of the interior surface and the exterior surface of the case.

The detailed parts description begins with FIG. 1. FIG. 1 shows the total invention component in a version of a manually flipped light attenuating shade. Piece 1 is the tinted plastic or tinted glass shade. Piece 2 is one leaf of a pin assembled hinge. Piece 3 is the hinge pin joining piece 2 to piece 4. Piece 4 is the second leaf of the hinge. Piece 5 is a tab piece which passes into a slot region of the mirror housing shell. Piece 5 is drawn tight against the underside of the mirror housing opposite the face of piece 4 which is pressing the grip on the mirror housing edge pinched between piece 5 and piece 4. Piece 6 is the wing nut and screw assembly that pulls pieces 4 and 5 into a pinch action to grip the edge of the mirror housing. Piece 8 is a tab piece that bears against the cylindrically formed region of the opposite hinge leaf to effect a drag movent arrest between the two leafs of the hinge. Piece 7 is the wing nut and screw assemble that pulls piece 8 into a drag grip action on the hinge. flexing movement. To recite identity of some of the parts again, there is piece 1 which is the tinted transparent panel. Piece 2 is a leaf of the hinge at the top of the panel (i.e. “top” when device is mounted and the tinted transparent panel is hinged down over the silvered mirror. Pieces 3 and 4 are also components of the hinge. Piece 5 is the holding clip that holds the hinge to the rear view mirror shell on the motor vehicle. As in this specific illustrative example piece 6 imparts the clamping force to piece 5. Piece 7 in conjunction with piece 8 imparts the latch mechanism force to the hinge.

FIG. 2 shows the hinge and latch mechanism in enlarged detail. Piece 8 is a latch or drag or brake that holds the shade in either of two service positions, i.e. to cover the silver mirror surface or to swing clear of the silver mirror surface.

FIG. 3 is the reverse face of FIG. 2.

There are many obvious equivalents of the parts recited so far. A few of such equivalents comprise a latch release mechanism similar to a hook and eyelet, a suction cup attachment means, a strap attachment means, a screw attachment means, a hinge of fiber or flexible plastic, a sliding bolt to lock the shade into position, a spring loaded live latch (as contrasted with a dead bolt), and much more.

FIG. 4 (shown on same drawing as FIGS. 2 & 3) is another way of designing a detent to hold the tinted shade piece 1 firmly in either of two selected positions. Piece 9 is a wavy collar that can move axially on piece 3 against spring piece 10. A small pin, piece 11 keeps piece 3 and piece 9 locked together for any rotational movement of hinge piece 4. Small pin piece 11 lies in a slot in piece 9 such as to only permit axial movement by piece 9 relative to pin 3. Thus piece 9 rides in and out over the mating wave contour of piece 2 and rests with maximum spring extension at either of two chosen holding positions for the light attenuating shade piece 1.

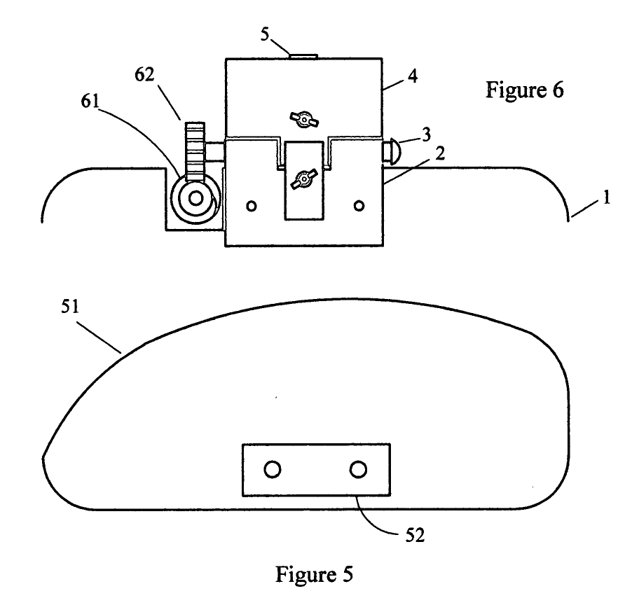

FIG. 5 shows a housing shell, piece 51, for the mirror where the shell has a flat spot at the top to accommodate screw fasteners or epoxy cement to hold fast the hinge part shown in FIGS. 2 and 3.

FIG. 6 shows an arrangement of a motor drive to operate the mirror attenuation shade between shade position and clear view position. In FIG. 6 piece 61 is a worm gear on the end of a motor shaft. Piece 62 is attached to rod piece 3 and is the spur gear driven by the worm gear. As piece 62 rotates so does piece 3 rotate. Assume piece 3 to be bonded (by weld, pin, glue or whatever) to piece 2. Assume piece 3 to be free to rotate within hinge leaf 4. Thus when the worm gear rotates, piece 1 is either swung up away from the face of the mirror or swung down to cover the face of the rear view mirror.

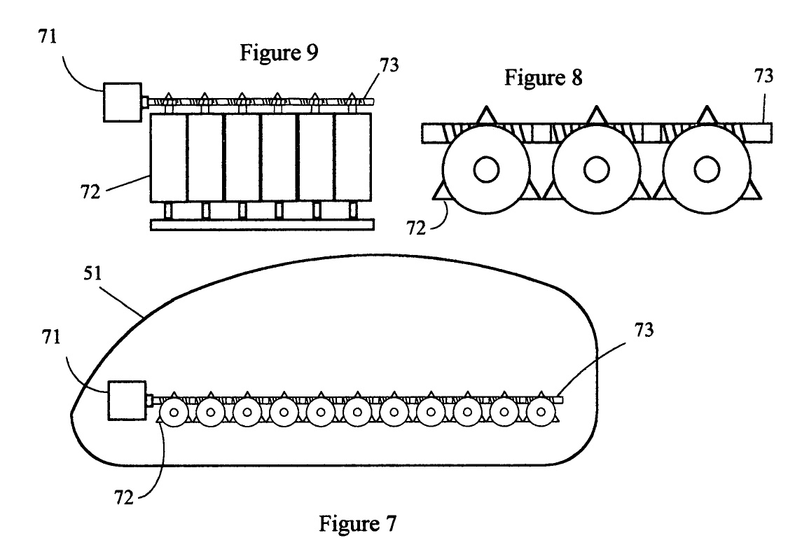

FIG. 7 shows a rotating triangular bar mirror structure driven by a motor. FIG. 8 is an enlarged top view of the drive mechanism to rotate the mirror elements. FIG. 9 is a full face front view of the mirror elements, pieces 72. Piece 71 is the drive motor that rotates worm gear piece 73 to turn the faces of the mirror array.

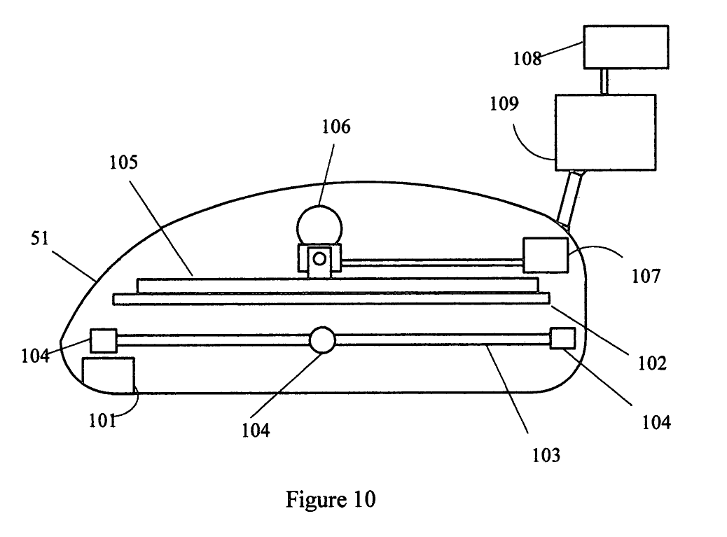

FIG. 10 is a symbolic block diagram of a fully automatic rear view mirror glare light attenuation system. Piece 51 is the mirror shell previously shown in FIG. 5. Piece 101 is a light sensor detecting head light glare from highway traffic following in the rear. Piece 102 is the silvered mirror. Piece 103 is the transparent glass in front of the silvered mirror which glass by front surface reflection maintains an attenuated image of following traffic when the silvered mirror has been tilted out of traffic image projection angle. Pieces 104 are the gimbals that enable a motor system (not shown) to set the transparent glass at its optimum angle relative to the eyes and to the choice of the motor vehicle driver. Piece 105 is the back plate holding the silvered mirror. Piece 106 is the ball of a ball & socket joint that supports piece 105. Piece 107 is the motor drive to set the angle of the silvered mirror. The electric powered adjustment of mirror angle is prior art equipment and may be copied from equipment presently on the highways. Piece 108 is a switch (optical switch or otherwise) that informs the logic system that the car is driving at night or is driving in the day light. Piece 109 is the embedded microprocessor that ties the sensor logic and motor response logic together to protect the motor vehicle driver from disturbing head light glare from following traffic.

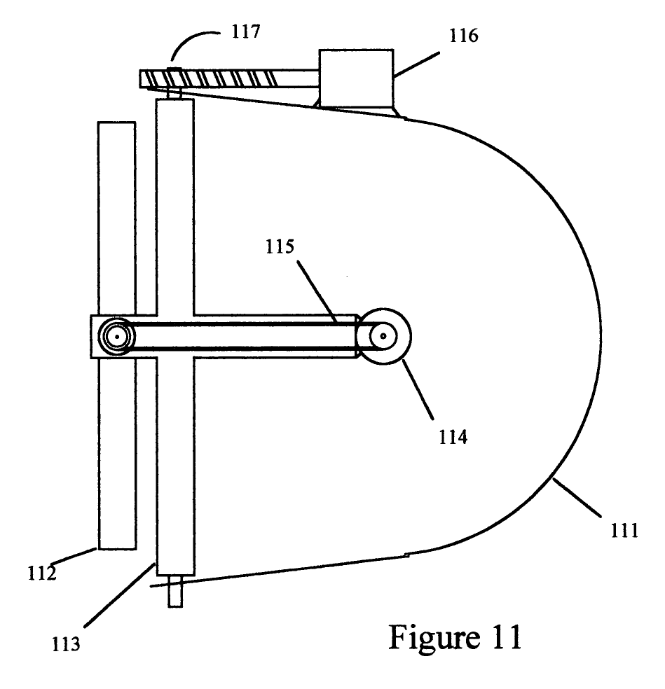

FIG. 11 illustrates 180 degree flipped mirror design. Piece 111 is the housing shell to amount the rest of the assembly. Piece 112 is the mirror, silver on the front, of attenuated reflectivity on the back. Piece 113 is the gimbals ring that encircles mirror piece 112. Suspension axis of piece 112 in the gimbals is perpendicular to the suspension axis of piece 113. Motor piece 114 drives via belt piece 115 the rotation of the gimbals axis of mirror piece 112. That is the motor drive to flip piece 180 degrees. Motor piece 116 acting through worm gear and spur gear assembly piece 117 acts on the gimbals axis of piece 113 to a small angular adjustment of the mirror perpendicular to the 180 degree flip rotation of the mirror.

This invention has a single effect objective, viz: attenuation of headlight glare from following highway traffic. However, there can be identified two separate marketing patterns manifested in two different design criteria. The simple hinged, manually positioned, flip up tinted plastic shade covers one market which is easy to enter and easy on supply tooling up. Then there are the deluxe model and super deluxe model, to be installed as automobile original equipment.

Turning now to a detailed description of the invention as a totally automatic, self operating unit we begin with a look at the existing outside rear view mirror hardware. Most of the outside rear view mirrors appear to have an electric motor in the shell case. The motor functions to adjust the orientation angle of the mirror. There are four motor drive wires. It would be a simple matter to add several more wires to the harness to drive a motor that operates the reflected light attenuation means.

There are two more electric control features to give full automatic operation. A light sensor such as a photoelectric cell responding to rear view headlight glare can serve to signal the equipment to activate the light attenuation means. There was at one time, and perhaps still available, a photo sensitive device that dimmed the headlights of an automobile in response to the light from an oncoming vehicle. That sensor technology should amply serve on the present invention to react to headlight glare from following traffic, even as it was originally intended to detect on coming traffic.

Another interesting design step follows from the question: “How will the invention know not to attenuate the mirror image during the full light of daytime?” One could add a second sensor such as a solar cell to monitor ambient light level. That seems to be going at the problem the hard way. That which should be the answer is that if the head light switch lever is not pulled on then it is daytime. With the headlight lever off the attenuation mechanism is disabled through a parallel electrical connector in the headlight switch. However, modem cars seem to always have the headlights on when moving Thus a solar cell sensor with a solid state relay would be the strategy if required.

The next design subject is construction of the three-way sign board style mirror illustrated in FIGS. 7, 8, and 9. Essentially it is a copy of the giant size scaled down 100 fold. We only need two reflective surfaces. Thus the motor drive may preferably operate to step forward one position and then to reverse to step back one position.

Mirror manufacturing is old technology. A vapor deposition, sputtered mirror deposit is an easy way to reduce mirror reflectivity.

Means for rotating an array of display surfaces is old technology. Aside from the advertising sign system referenced above the common venetian blind design is capable of displaying in succession either of two reflective surfaces.

FIGS. 7, 8, and 9 illustrate in more detail the function of an attenuating system copied from the rotating advertising sign style.

Piece 71 is drive motor at the end of the array of vertical mirror segments, pieces 72. FIG. 8 shows a portion of the array of vertical mirror segments in enlarged view. Piece 73 is the extended worm gear that drives a spur gear on each of the vertical mirror segments.

FIG. 10 shows an alternate approach to the attenuation problem. Instead of intercepting the headlight glare beam with a tinted transparent light filter the existing technology is used which is to tip the mirror to deflect the intense light source. The motorist reaches up and flips a tab to deflect the beam. That works for an inside mirror. For the outside mirror the manual operation leaves something to be desired, especially on a rainy day or on a cold winter day requiring lowering of the window and reaching outside. Instead, FIG. 10 shows how to make the whole process automatic. Having achieved that goal it becomes attractive to install the same automatic system inside the motor vehicle.

In FIG. 10 piece 51 is again the mirror shell case. Piece 101 is the photoelectric glare light sensor. Piece 102 is the silvered rear view mirror. Piece 103 is the transparent front glass which is capable of reflecting an attenuated image off its front surface. Pieces 104 are the gimbals bearings with position drive motors and the rest of the gimbals frame that position front glass piece 103. Piece 105 is the silver mirror backing frame. Piece 106 indicates a ball and socket arrangement that supports piece 105. Piece 107 represents the pair of drive motors that position the reflection angle of the silvered mirror assembly. Piece 108 is the switch logic source for saying to the system, “it is day time” or “it is night time.” Piece 108 may represent the auxiliary electrical contact pair mechanically integrated with the manually operated headlight switch. However, if cars are all being built with the headlights turned on whenever the car is running then switch piece 108 may be such a device as a solar cell and relay to distinguish day from night. Piece 109 is the embedded computer system that coordinates the sensor inputs with the control motor outputs. For example, switch 108 says, “it is nighttime” and piece 101 says “there is intense light glare from the rear direction”. Logic coordinator piece 109 directs the motor system piece 107 to deflect mirror support piece 105 a specific amount and then to restore the mirror to its exact previous angle after piece 101 signals “all clear”. Logic coordinator piece 109 also receives and stores into memory the preferred angle settings for piece 102 and piece 103. The preferred angle settings can be made in any number of ways, one method being use of the same sort of procedure that is used to set the time and date on a digital clock. An alternate but primitive way to set angles is with a screw driver and ports that reach the mounting supports of the mirror reflective surfaces. Another way is to put a linear index bar with digital output on the part to be moved a controlled amount. There is such a mechanism available on the market, it being incorporated in vernier calipers. Also some machine tools have such a linear index bar giving digital read out display for movement of cutting tools. Thereby, logic coordinator piece 109 will know where every moveable piece is at any time, compare with its memory data bank, and issue corrective movement signals as required.

### DEFINITION OF TERMS

This section of the petition for letters patent seeks to establish unambiguously in the description section of the petition the identification of the key terminology relied upon in the claims section for delimiting the scope of the claims.

The words “light attenuating device” would designate such means as would lower the intensity of radiation, e.g. measured in lumens or in foot candle power, viewed by observer.

A “tinted transparent piece” could be any optical transmission piece such as glass or plastic polymer which by material incorporated into the piece results in lower intensity of transmission of an optical image.

The word “aside” as in the expression “moving the tinted transparent piece aside” means moving up or down or left or right, being any direction except straight along the optical viewing track of the motorist.

The word “hinge” means a flexible bonding structure between two objects.

The term “position holding piece” designates any structure that immobilizes any two objects that might otherwise be capable of moving relative to one another.

The term “friction drag tab” is a mechanism that tends to immobilize an object by virtue of the mechanism being forced against the object.

The word “detent” as used in the claims has the same meaning as stated in the dictionary.
Per above description, corresponding claims are attached.

1. A light attenuating device for attachment to the outside rear view mirror of a highway motor vehicle such as will attenuate the glare from headlights of following highway traffic.

2. The device of claim 1 wherein a tinted transparent piece is mounted over the rear view mirror of the highway motor vehicle.

3. The device of claim 2 wherein the tinted transparent piece is attached to the existing mirror mount found on the motor vehicle, through a hinge piece which hinge piece enables positioning of the tinted transparent piece over the mirror to attenuate reflected light and that enables moving the tinted transparent piece aside to allow full reflectivity by the mirror of the rearward view image reaching the driver of the motor vehicle.

4. The device of claim 2 comprising position holding piece to hold fast in position the tinted transparent piece over the mirror to attenuate reflected light and that holds fast, in a second position, the tinted transparent piece to one side to allow full reflectivity by the mirror of the rearward view image reaching the driver of the motor vehicle.

5. The device of claim 4 wherein said position holding piece is a friction drag tab.

6. The device of claim 5 wherein said position holding piece is a detent fashioned as a friction drag tab of which tab the end drops into a recess under spring loading on the tab.

7. The device of claim 5 wherein said position holding means is a detent fashioned as a helical spring pressing together two cylindrical hinge axis parts of cylindrical shape and of wavy ends mating parts of which wavy ends drop into the joining recess under spring loading to fix the shade in a covering position with one mating recess alignment and to fix the shade in an uncovered position with an alternate mating recess alignment.

8. A light attenuating device for attachment to the outside rear view mirror of a highway motor vehicle such as will attenuate the glare from headlights of following highway traffic by activation of a motor driving a light attenuation shade attached to said rear view mirror assembly.

9. The device of claim 8 wherein said motor that turns a worm gear that rotates a spur gear that turns a leaf of a hinge that is attached to a light shade which by said motor is caused to move into and out of the optical path of the mirror.

10. The motor operated device of claim 8 wherein a photoelectric cell senses the glare from the headlight of following highway traffic and an electric solar cell senses the presence of darkness of night so as to supply the logic to the assembly to make operational the attenuating shade of a rear view mirror during the night time hours.

11. The electric motor operated device of claim 8 wherein a photoelectric cell senses the glare from the headlight of following highway traffic, and an electric connection to the motor vehicle head light switch which in the darkness of night time supplies the logic to the assembly to allow the attenuating shade to block following traffic head light glare during night time hours.

12. Light attenuating device designed to function as the rear view mirror of a highway motor vehicle such that the device attenuates the glare reaching the eyes of the driver from headlights of following highway traffic, such design comprising a photo sensor to detect following traffic headlight glare; such design comprising sensor to distinguish between light of daytime sun and following traffic head light glare; such design comprising motor means to drive the engagement and disengagement of the light attenuation automatically in response to sensor input.

13. The device of claim 12 comprising means to deflect the reflection angle of the mirror.

14. The device of claim 12 comprising means to reduce the reflectivity of the mirror.

15. The device of claim 12 comprising an array of mirror segments that can be successively displayed and concealed to reflect fully and to attenuate reflection of the mirror device.

16. A rear view mirror for highway motor vehicles with the mirror mounted on an axis such as to enable the mirror to flip from its front face mirror to its back face of lower reflectivity to the purpose of attenuating the headlight glare of following motor vehicle traffic.
